(19) United States
(12) Patent Application Publication
(10) Pub. No.: US 2008/0220138 A1
(43) Pub. Date: Sep. 11, 2008

(54) Process and Equipment to Deactivate Grains

(75) Inventors: Alcir Dallagnol, Estado do Rio Grande do Sul (BR); Ari Osvaldo Baldus, Estado deo Rio Grande do Sul (BR)

Correspondence Address: SUGHRUE MION, PLLC, 2100 PENNSYLVANIA AVENUE, N.W., SUITE 800, WASHINGTON, DC, 20037, US

(73) Assignee: INTECNIAL S/A, Erechim (BR)

(21) Appl. No.: 11/913,733

(22) PCT Filed: Nov. 10, 2006
(86) PCT No.: PCT/BR2006/000250

§ 371 Date: Dec. 17, 2007

(30) Foreign Application Priority Data
Mar. 31, 2006 (BR) PI0601166-7

(51) Int. Cl. A23L 1/01; A23L 1/10

(52) U.S. Cl. 426/523; 426/618

(57) ABSTRACT

The aim of this patent is a basically cylindrical vertical body where the displacement of grains occurs through gravity.

It is constituted by an antechamber (01) through which the grains enter and are pre-heated when they come in contact with an amount of parallel tubes (02), heated by steam. In the lower part of the chamber (01), there is an entry rotational valve (11) through which the grains pass to the heating chamber (18).

Inside the heating chamber (18), there are diverse diametral gutters (14) arranged in opposite positions, with “V” inverted shape walls through which steam is injected into the heating chamber (18) that has a multiple rotational valve of the base (19) in its lower part over the cylinder of the plates (21) heated by steam, where there is an upper heated (22), second (27) and third (28) plates upon which rotational paddles (25) turn that make the grains fall through an opening (26) and a download gutter (32) in the upper one and second plate, and there is a lower rotational valve (31) under the third one.

It is well known that several grains that are used in human and animal feeding need previous treatment in order to be consumed, such as beans and soybeans, which are toxic “in natura” state, having harmful protein contents such as antitrypsin, phytohemagglutinin, phytic acid, and urease enzymes.

For cases where grains are used raw for animal feed production, it is necessary to perform the deactivation of harmful compounds previously, which is normally done through temperature heating, and determined times.

Another process is, after having extracted the oil, the rests are then toasted, which costs US$12.00 per processed soybeans ton, approximately.

Another known process is also the one where the body of the processor that contains the grains is heated through an electric resistance.

For the aforementioned processes, there is an elevated process cost and the time necessary for grain deactivation is thirty minutes to an hour, which results in loss of protein values.

The grain sterilization heating process is also used to eliminate fungi and toxins mainly, which are harmful for human and animal feeding.

The document U.S. Pat. No. 4,413,018 describes a method of processing oat groats for imarting shelf stability to the groats by inactivating the enzymes of the groat without causing oxidation, wherein dehulled uncut, unrolled oats are conditioned by indirect steam heat at a temperature in the range of about 77° C. to 104° C., then the conditioned oats are tempered by steaming resulting in tempered oats having a moisture content in the range of 12-35% by weight base don the weight of the oats, and finally, the tempered oats are dried and toasted.

Due to the fact that these processes are currently costly and harmful for the quality of the food, a new process and equipment were developed wherein the processing cost is very low and perfect control over the exposure temperature and time of exposition can be attained, thus resulting in cheaper and better quality foods.

The documents U.S. Pat. No. 5,501,143 and U.S. Pat. No. 5,381,731 describes vertical steam injection devices for conditioning particulate material, e.g. grains, with one or more hollow modules having tops and open bottoms to impart an irregular flow path to the particles being conditioned in the chamber and to supply steam into the chamber.

As a result of the aim of this patent, there is low energy consume, return of short-term investment, final product with high added value, and an integral product for there is no aggression to the integrity of the oil, preserving the grain for a long time.

It basically consists of an exposure of the grains to direct contact with saturated steam for humidification and heating of grains during its entire gravitational displacement through a vertical cylindrical body, wherein the steam distribution is performed through dephased steam entries arranged on inverted “V” shape chutes that are located at different levels and angles so as to enable a uniform distribution of the steam on the entire grains mass while their continuous displacement occurs through the cylindrical body.

The continuous flow of the product is controlled through rotational valves at the cylinder's entry and exit points which are monitored by a level control at the loading hopper, and a flow control at the exit of the pre-drying chamber.

The balance of the product mass and the steam are controlled so as to allow the entire grain mass in this phase to reach a temperature of approximately 100 to 103 degrees Celsius, and humidity of around 19% before exiting the cylinder, for the case of soybean deactivation.

The next phase comprehends the exposure of the heated and humidified grain mass to a heated surface in chambers composed by plates heated with steam, and a rotational paddle system to supply the displacement of the product and a uniform contact with the heated surface. The grain mass will attain the necessary temperature for the deactivation in the first chamber, and it will then be immediately released to the other chambers that aim at pre-drying it, which will combine heating with exhaustion of steam from the chamber, wherein negative pressure can occur.

From this stage, the already deactivated grain mass can be released to a cooling system that can be added to the equipment itself through the installation of another specific cooling chamber, or of an independent system.

The heat of steam withdrawn from the pre-drying chamber can be optionally recovered and reused to pre-heat the grain mass in the feeding hopper, or another sector.

For a better understanding, the aim of this patent is represented in:

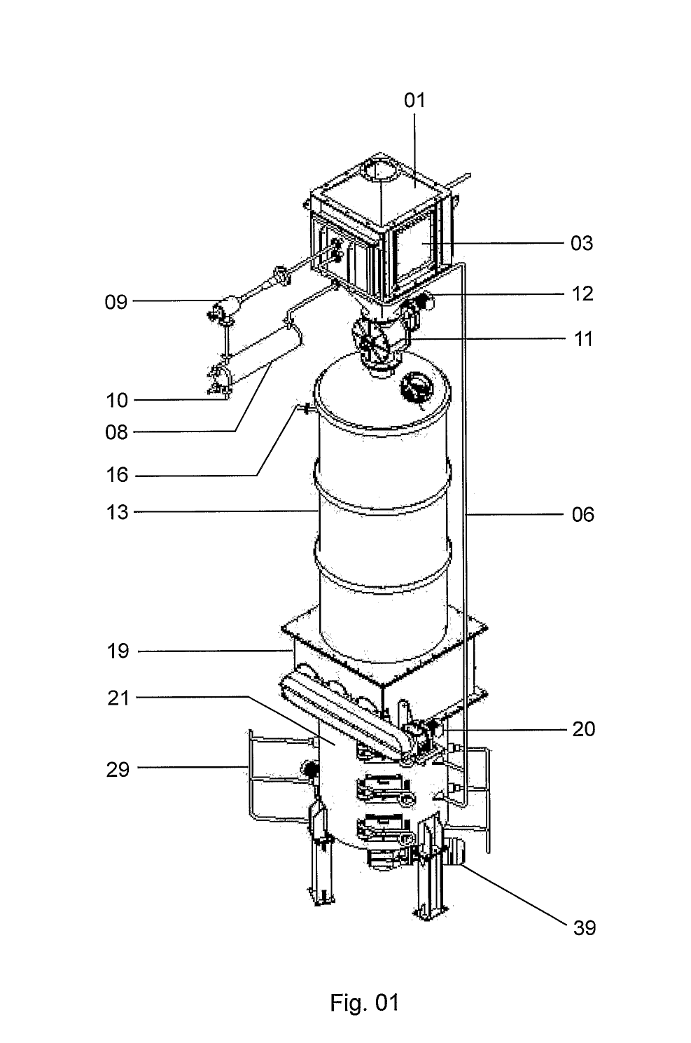

FIG. 01—Perspective view representing the steam reuse circuits, and the condensation of chambers with heated plates;

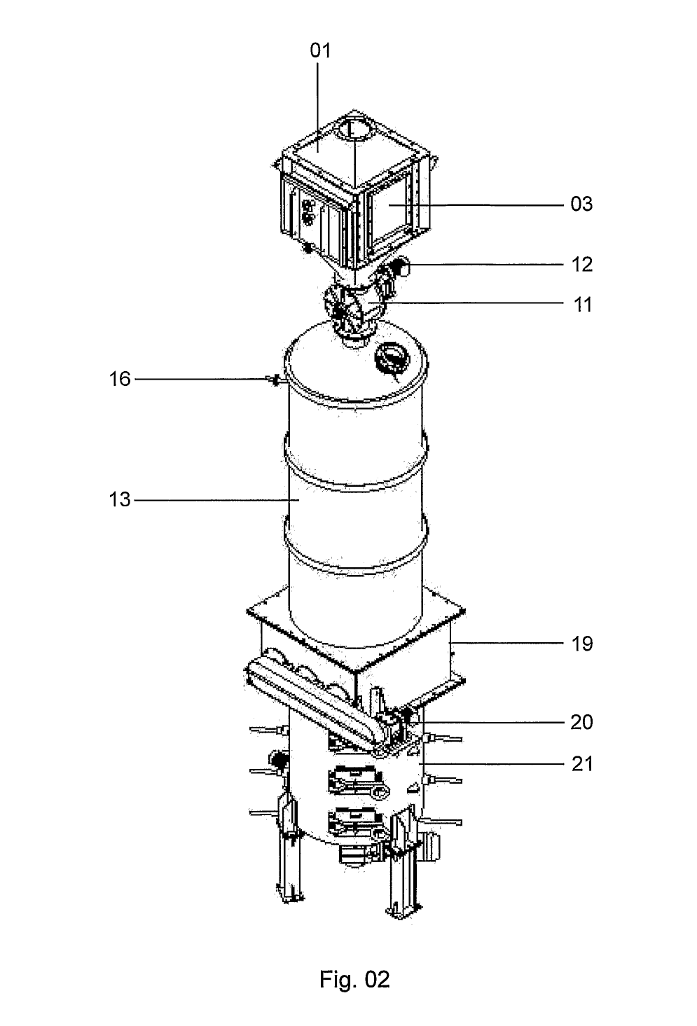

FIG. 02—Perspective view of the structure, not representing the steam and condensation nets for better understanding;

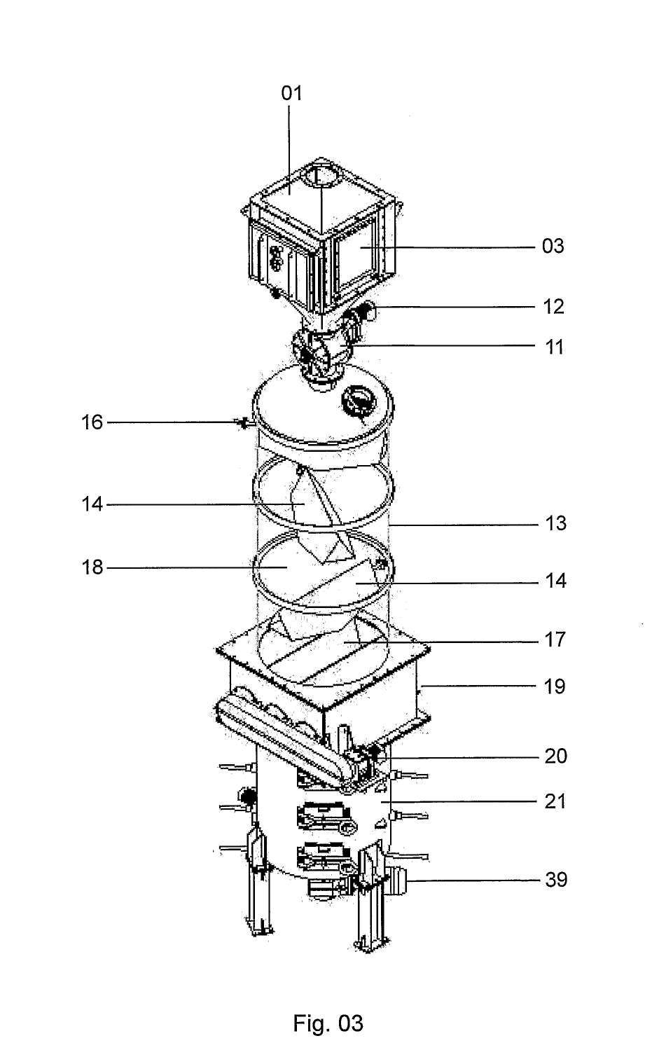

FIG. 03—Perspective view with carcass cut, not representing the steam and condensation nets for better understanding;

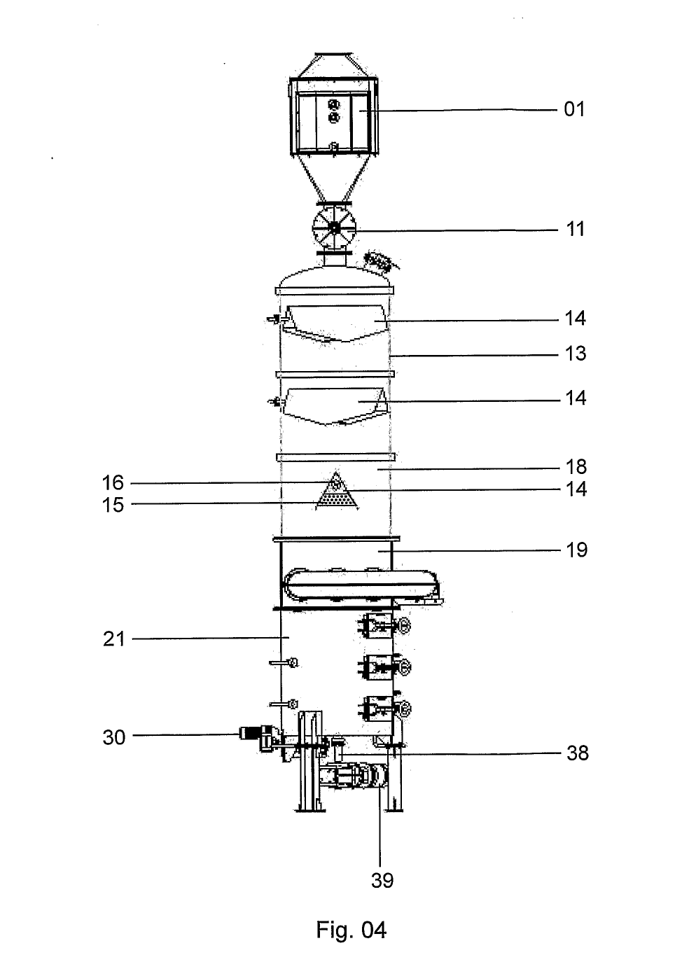

FIG. 04—Lateral view with carcass cut;

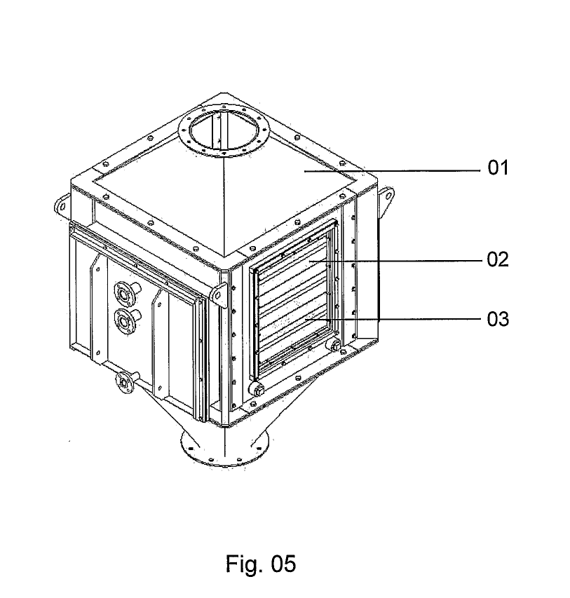

FIG. 05—Perspective view of the antechamber;

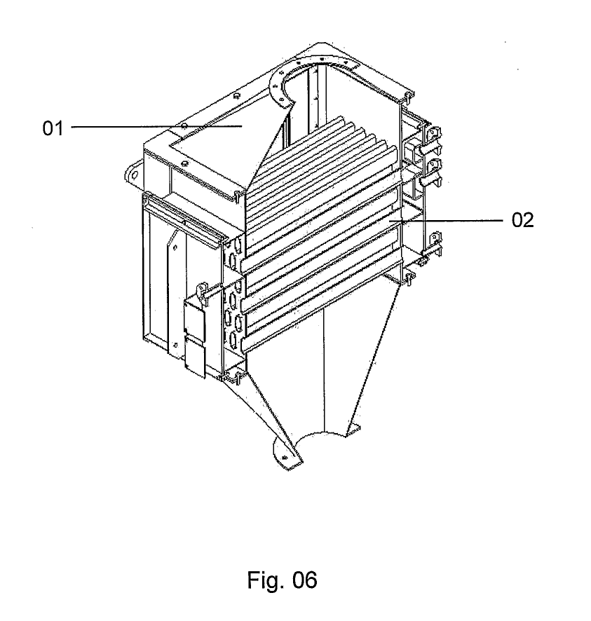

FIG. 06—Perspective view of the antechamber with partial cut;

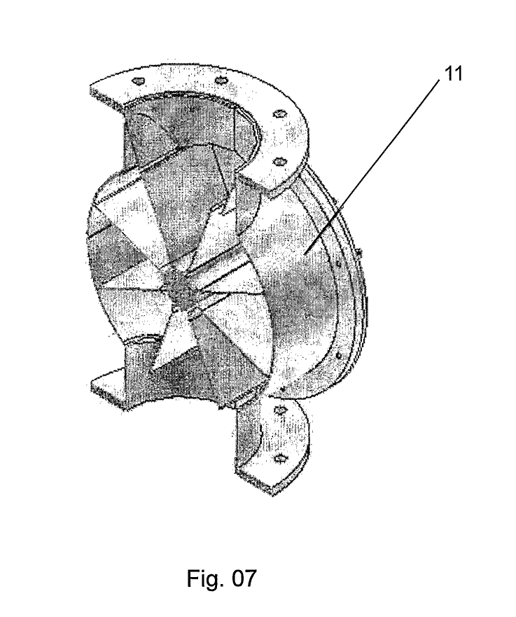

FIG. 07—Perspective view, in cut, of the first valve;

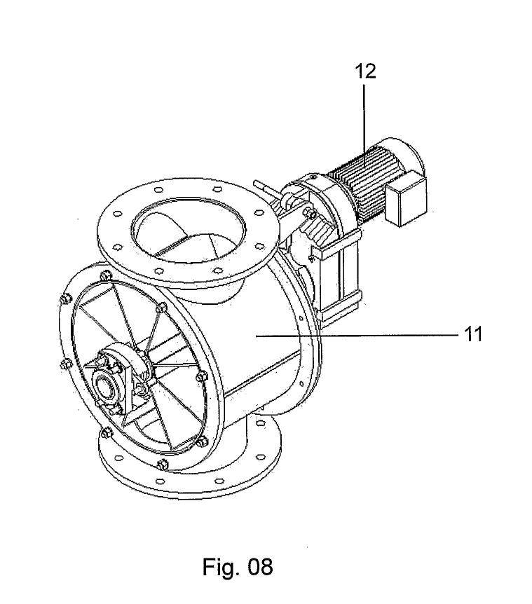

FIG. 08—Perspective view of the first valve without lid;

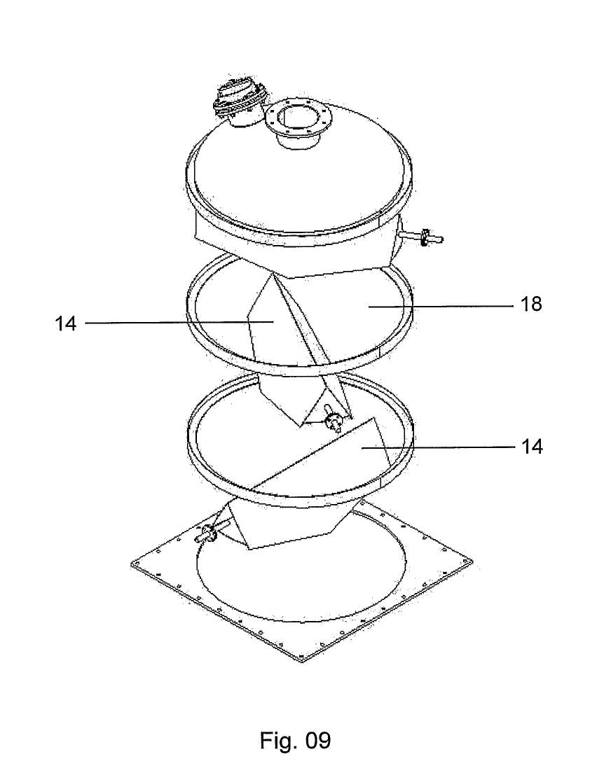

FIG. 09—Perspective view, in cut, of the direct steam heating chamber;

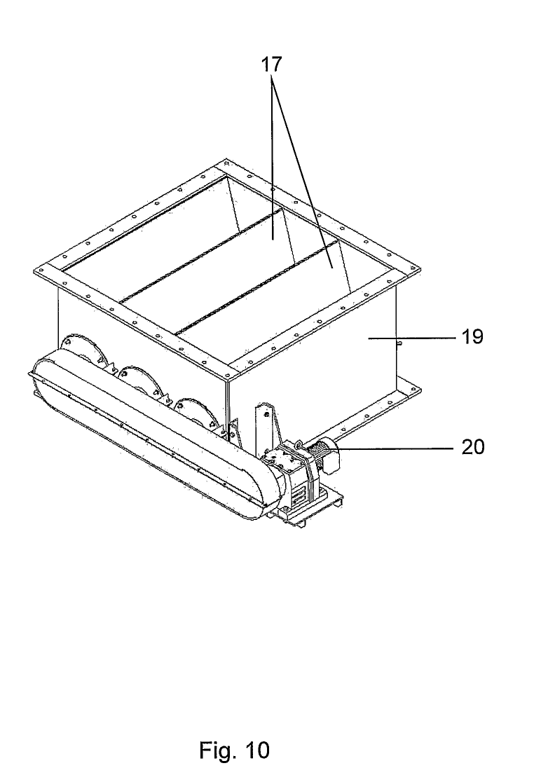

FIG. 10—Perspective view of the chutes and valves of the base;

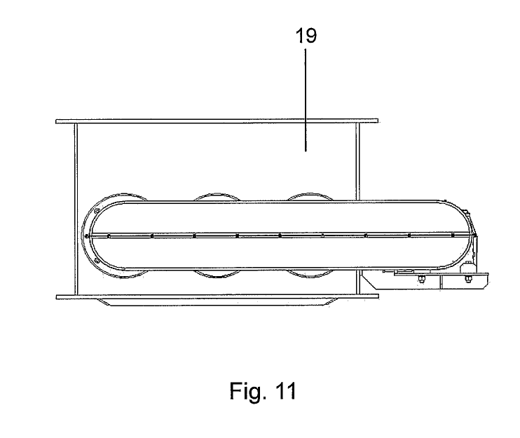

FIG. 11—Lateral view of the chutes and valves of the base;

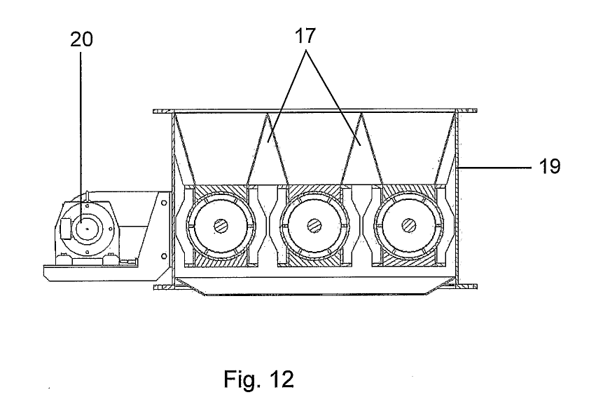

FIG. 12—Cut view of the chutes and valves of the base;

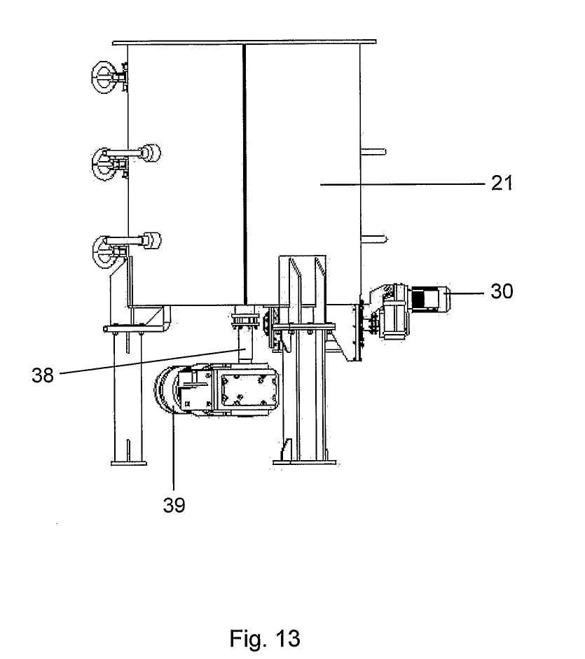

FIG. 13—Lateral view of the body of heated plates;

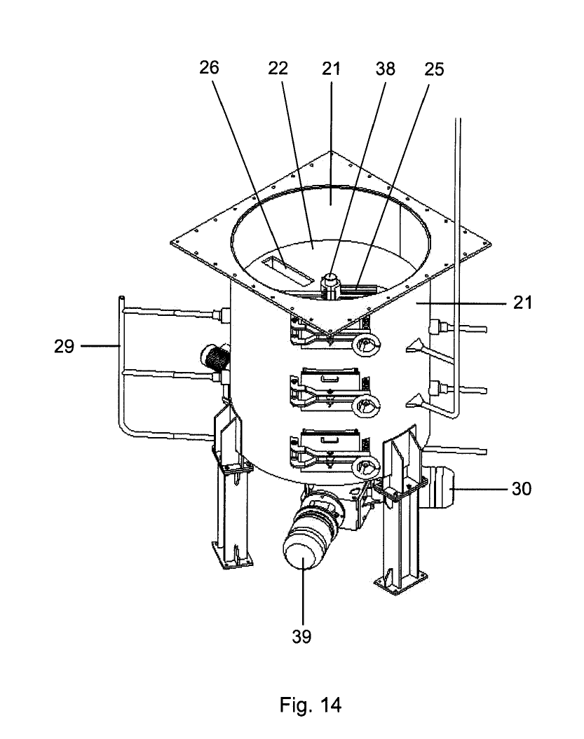

FIG. 14—Perspective view of the body of heated plates;

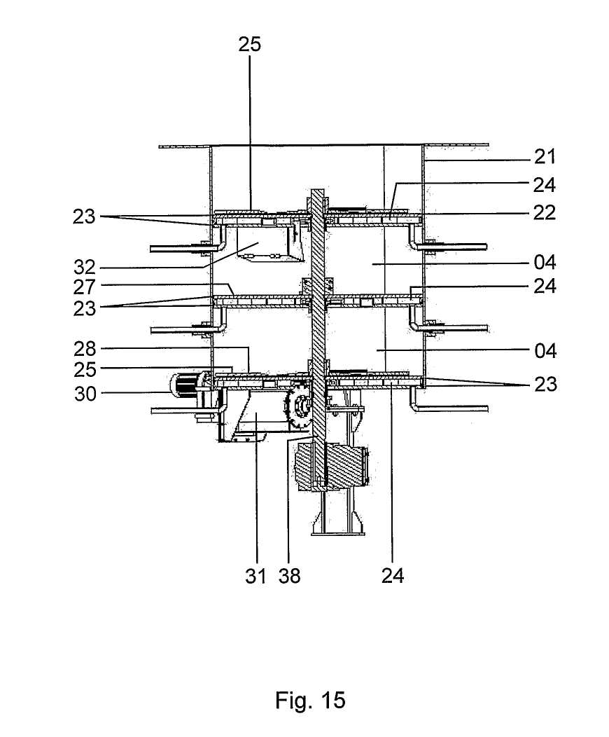

FIG. 15—Lateral view, in cut, of the body of heated plates, lower valve and operation of the rotational paddle shaft;

FIG. 16—Upper view of the body and heated plates;

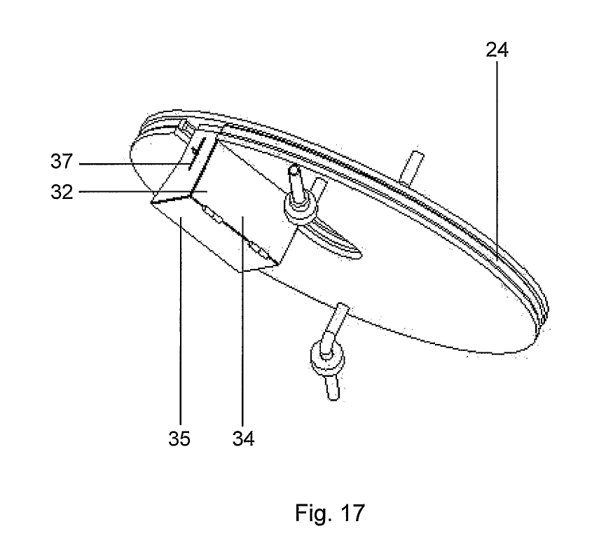

FIG. 17—Perspective view of heated plate;

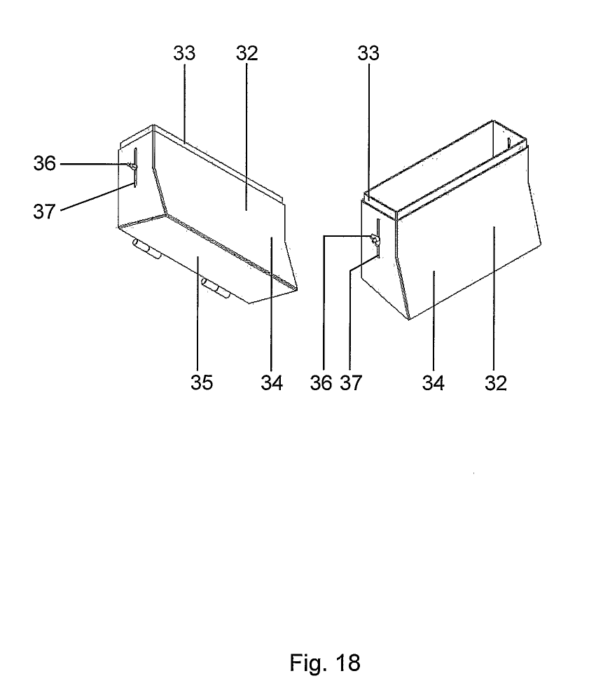

FIG. 18—Perspective view of download gutter of heated plate;

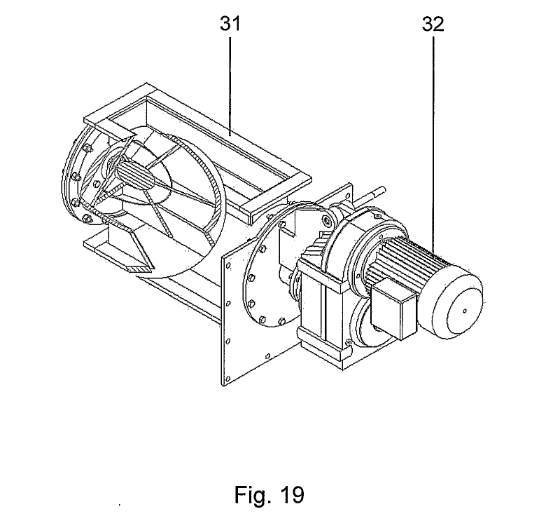

FIG. 19—Perspective view of rotational valve for lower download.

As we can see in the annexed figures, the aim of this patent is constituted by a basically cylindrical vertical body where the displacement of grains occurs due to gravity.

Through a conventional and more appropriate mechanism for the installation where it operates, the grain is supplied through the upper part of the antechamber (01) which is formed by a closed body provided with lateral inspection lids (03), one or more transparent ones so as to visualize the grain level inside it, and an inverted cone-shaped trunk base in which an amount of parallel tubes (02) is arranged, being punctured in two sections, heated with steam, hot water or both. The heating of the tubes (02) of the antechamber (01) can be done with steam generated directly by the boiler, not represented for it is a source of external energy, by the steam of the pre-drying chambers (04) conducted through the pre-drying steam gutters (06), or increased by the use of steam from the steam ejector (09) that aspirates these steams.

In another option, the heat of one or more parts of the process can be reused. When the steam and water are collected in low pressure sectors, they are aspirated or pumped by a steam ejector (09), whose steam and heat can also be used to heat the antechamber (01).

The remaining heat can also be used and withdrawn through the condenser (08) so as to pre-heat the burning air in the boiler, or use it for an additional drying chamber, if necessary.

The antechamber (01) tubes (02) aim at pre-heating the grains, increasing the output of the equipment.

After having gone through the tubes (02), the steam that comes from the pre-drying (04) chambers is canalized to the condenser (08), whose function is to condense the remaining steam that may not have been condensed in the thermal exchange that occurs in the antechamber tubes. All condensation is released from the condenser as hot water through the exit gutter of the condenser (10).

The time the grains remain in this antechamber (01), as well as the grain volume that will go to the next stage is controlled by the entry rotational valve (11) which is activated by a controlled engine (12). This valve has also the task of retaining pressure when the pressure in the heating chamber (18) is different from the atmospheric pressure. This operational pressure can be atmospheric or higher than the atmospheric one. The temperature inside it can vary between 90 to 120° C. approximately, depending on the utilization and grain type.

Inside the heating cylinder (13), where the heating chamber (18) that is filled with grain is located, there are several diametral gutters (14) arranged in opposed positions at different angles and levels of the walls, with inverted “V” shapes in whose lower part, a perforated plate (15) for steam exit can be found, which is injected through the steam entries (16) on the walls of the heating cylinder (13) onto the diametral gutters (14); this steam is conducted through the steam tubing, whereby this circuit is not represented in the figures so as to simplify and make the understanding easy. The perforated plate (15) has orifices smaller than the grains, avoiding thus grain from entering the gap under the diametral gutters (14).

This steam heats the diametral gutters (14), which by being arranged at opposed angles and heights, allow the displacement of grains and their mixture at the same time, provoking a homogeneous heating of the entire mass of grains. These diametral gutters (14) heat the grains through direct contact for they are heated by the steam that enters its inverted “V” shape gap; this steam exits the perforated plates (15), mixing with the descending grains in the heating chamber (18), heating and humidifying them as well so as to reach the optimum deactivation conditions.

Next, these grains flow through gutters at the base (17) onto a ramp that directs the grains to the multiple rotational valve of the base (19) that is operated by an engine controlled at the base (20) which regulates the amount of grain exit and consequently, the level or filling of the heating chamber (18), retaining the pressure inside the heating chamber (18) at the same time, if necessary.

After going through the multiple rotational valve of the base (19), the grains go to the cylinders of the heated plates (21), falling onto the upper heated plate (22) which is constituted by two metallic discs (23), apart from each other, in whose gap (24) the steam is introduced, heating thus the plate and therefore the grain through direct contact until it reaches the necessary temperature for the deactivation. The homogeneous heating is guaranteed by the rotating paddle (25) that turns according to a vertical shaft (38) that is activated by the engine (39) and drags the grain mixture to the pre-drying chambers (04), making them all have contact with the upper heated plate (22), and making the grain fall through an opening (26) onto the second heated plate (27), where the pre-drying inside this chamber will occur under negative pressure provoked by the steam ejector (09), combining the heating of the plate with the exhaustion of water steam, which once is heated, will be used to pre-heat the grain in the antechamber (01), passing through the vacuum or aspiration system through the steam ejector (09) and pre-drying steam gutters (06).

Similarly, the grains will be dragged by the rotating paddle (25), making them fall through an opening (26) provided with a download gutter (32) onto the third heated plate (28) where there will also be a water steam exhaust. There can also be more or less heated plates.

The openings (26) in the upper heated plate (22) in the second heated plate (27), and in the third heated plate (28) are vertically misaligned in regard to one another.

At the openings (26) of the upper heated plates (22) and second heated plate (27), download gutters are connected (32), each of which is constituted by a parallelepiped wall (33) which fits and is fastened to the opening (26), in whose lower extension, a trapezoidal box (34) that is provided with a lower bascule lid (35) is connected.

The grain gap of a pre-drying chamber to the other, and the grain exit of the equipment are regulated by the controlled output of the lower rotational valve (31), activated by the controlled engine of the lower rotational valve (30) that maintains the grain mass in the pre-drying chamber of the third pre-heated plate at a determined level, for it controls the grain exit through the opening (26) of this third pre-heated plate (28). When the grain level reaches the bottom of the trapezoidal box (34), the lower bascule lid (35) closes and avoids the passage of grain to the pre-drying chamber (04) that is above.

The grain mass height is regulated in the chambers of both upper heated plates by making the trapezoidal box (34) slide over the projection of the paralellepipedic wall (33), fixed by a screw and nut (36) that slide in the lateral grooves (37).

There is another steam net that supplies the steam entries (16) of the gutters and another at the steam entries of the heated plates (29). There is also a gutter for condensed water (10) that gathers the condensed water of the condenser (08), and condensation tubing that gathers the steam and condensed water from the upper heated (22), second (27), and third (28) plates.

Finally, there will be an exit lower rotational valve (31), activated by a controlled engine of the lower rotational valve (32), aiming at maintaining the vacuum in the pre-drying chamber (04) and regulating the exit flow of the grain and consequently, its time of permanence in the pre-drying chambers (04).

Next, the grain will follow to the cooling equipment, which can be added to the deactivator or be independent, where there can be heat recovery.

1-2. (canceled)

3. EQUIPMENT TO DEACTIVATE GRAINS which encompasses a basically cylindrical body with vertical displacement of the grains by gravity, characterized by the fact that it presents:
a) An antechamber (01) disposed on the upper part of the equipment; said antechamber provided by side inspection lids (03) and an inverted conic trunk base equipped with a plurality of parallel tubes (02), which are trespassed inwardly in two sections;
b) An entrance rotating valve (11) triggered by a controlled motor (12) arranged on the base of the antechamber (01);
c) A condenser (08) connected to the antechamber (01), said condenser (08) equipped with a steam ejector (09) and an escape condenser channel (10) that releases the condensed steam;
d) A heating cylinder (13) interconnected to the entrance rotating valve (11), said heating cylinder (13) presenting, in the internal region, the disposition of a heating chamber (18) equipped with diametric chutes (14) arranged in a misaligned way, at different angles and levels, of walls in inverted “V”, said heating chamber (18) presenting in the lower part a perforated plate (15) for the escape of the steam which is injected through the steam entrances (16) on the heating cylinder wall (13) under the diametric chutes (14);
e) Base chutes (17) arranged in ramps and positioned below the diametric chutes (14), said base chutes (17) connected to the multiple rotating valve of the base (19) and triggered by a controlled motor of the base (20);
f) Cylinders of the heated dishes (21) arranged below the multiple rotating valve of the base (19), said cylinders (21) equipped with an upper heated dish (22), consisting of two metallic disks (23), away from each other, in which spacing (24) steam is introduced, presenting a revolving shovel (25) that spins according to a vertical axis (38) triggered by a motor (39) that drags and mixes the grains by pre-drying chambers (04), including an opening (26) provided with discharge tap (32) for the discharge of the grains over a second heated dish (27) and a third heated dish (28);
g) escape lower rotating valve (31), triggered by a motor controlled by the lower rotating valve (32), which keeps the vacuum in the pre-drying chamber (04) and regulates the output flow of the grain as well as the time of permanence in said pre-drying chamber (04).

4. EQUIPMENT TO DEACTIVATE GRAINS, in accordance with claim number 3, characterized by the fact that the tubes (02) are heated directly by steam derived from the boiler.

5. EQUIPMENT TO DEACTIVATE GRAINS, in accordance with claim number 3, characterized by the fact that the tubes (02) are heated by steam from the pre-drying chamber (04), led by the channeling of the pre-drying steam (06) added by the use of the steam ejector (09).

6. EQUIPMENT TO DEACTIVATE GRAINS, in accordance with claim number 3, characterized by the fact that the discharge taps (32) present a parallelepiped wall inserted and fixed in the opening (26), with lower elongation coupled to a trapezoidal box (34) provided with a lower window lid (35), said trapezoidal box (34) sliding over the projection of the parallelepiped wall (33) fixed by a bolt and nut (36) which slides in the lateral tears (37), preventing the passage of grain from the pre-drying chamber (04) positioned above.

7. PROCESS TO DEACTIVATE GRAINS USING THE EQUIPMENT CLAIMED IN 3, characterized because it involves the stages of:
a) Pre-heating the grains in the ante-chamber (01);
b) The grains are displaced by gravity to the heating chamber placed inside the heating cylinder (13);
c) The grains are displaced through the heating cylinder (13) through the heated chutes (14), promoting the homogeneous heating and undergoing a moisturizing process as a result of the steam that comes out of the perforated plates (15);
d) The grains flow through the base chutes (17) to the multiple rotating valve of the base (19), which regulates the flow of the grains;
e) The grains go to the cylinders of the heated dishes (21) falling over the upper heated dish (22), with a revolving shovel (25), which drags and mixes the grains in the pre-drying chambers (04) and forwards them to an opening (26) over the second heated dish (27), where it undergoes pre-drying under negative pressure, after the opening (26) with the grain mass being deposited over a third heated dish (28);
f) The grains move on for cooling and/or final drying.
